(19) United States
(12) Patent Application Publication
(10) Pub. No.: US 2002/0154097 A1
(43) Pub. Date: Oct. 24, 2002

(54) Auxiliary device for edting document

(76) Inventor: Rich Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/838,223

(22) Filed: Apr. 20, 2001

(51) Int. Cl. G09G 5/00

(52) U.S. Cl. 345/168

(57) ABSTRACT

An auxiliary device for editing document comprises a computer peripheral and a modular key set with document editing function. The modular key set is arranged on the computer peripheral and connected to an I/O bus of the single-chip microprocessor. Therefore, user can directly use the modular key set to edit document without invoking a composite key or mouse.

### FIELD OF THE INVENTION

The present invention relates to an auxiliary device for editing document, especially to an auxiliary device connected to a computer peripheral for facilitate document-editing task.

### BACKGROUND OF THE INVENTION

The computer hardware and software have rapid progress as the processing speed of computer is growing faster. However, the document-editing tool has insufficient development as compared with the progress of computer hardware and software.

In general, the document-editing task by computer is achieved by typing with keyboard and with the help of mouse. The typing and editing of document require frequent operation of the keyboard and mouse. It is easy for the typewriter to have industrial disease.

The ergonomic keyboards have been developed to overcome these problems. However, the prior art ergonomic keyboards still require the use of mouse. Moreover, some keyboard manufactures have developed multimedia keyboard, wherein a plurality hot keys are incorporated on the standard keyboard and specific driver is also developed for operating this keyboard in Windows environments. When user presses a specific hot key, a specific function is executed. However, the multimedia keyboard still has following problems:

1. The number of hot keys is limited by keyboard area and twenty hot keys are nearly a maximum.

2. A driver program is required, which occupies system resource and reduce operation speed. The installation of software and compatibility of software are also problems.

For example, the popular Microsoft Office software has provided tools including word, excel, power point etc. Those programs enable user to finish document like personal and commercial letters, spread sheet and presentation data. However, in editing above documents, the user needs to operate keyboard, mouse and frequently composite keys on keyboard to perform certain editing operation. It is still inconvenient for user.

### SUMMARY OF THE INVENTION

It is an object of the present invention to provide an auxiliary device for editing document to enable user to directly edit document on keyboard. A modular key set is arranged on the computer peripheral and connected to an I/O bus of the single-chip microprocessor. The modular key set is composed of function keys such as cut key, paste key, copy key and mark key. The user uses the mark key to mark a segment of document, the cut key to cut the document segment in the marked region, and up arrow, down arrow, left arrow and right arrow to move cursor to a specific region. Afterward, the user can use the paste key or the copy key to paste or copy the selected document segment to the position of cursor. Therefore, user can directly use the modular key set to edit document without invoking a composite key or mouse.

It is another object of the present invention to provide an auxiliary device for editing document, wherein user can perform a specific function by pressing only one key without invoking a composite key or mouse. The moving times and ranges of hand can be saved.

It is still another object of the present invention to provide an auxiliary device for editing document, which does not require any support of driver program. Therefore, the auxiliary device for editing document has not the problem of software compatibility. This is different to conventional hot key, which requires support of driver program.

It is still another object of the present invention to provide an auxiliary device for editing document, which is independent of keyboards for various countries. For example, the redo and undo operation can be executed by typing CTRL+Z and CTRL+Y, respectively. However, the alphabet arrangements on keyboard are different for different countries. In Germany keyboard, the positions of “Z” and “Y” are opposite to those of English keyboard. As shown in FIGS. 1 and 2, different functions will be executed for these two types of keyboards. Therefore, the composite keys cannot be arbitrarily assigned.

The various objects and advantages of the present invention will be more readily understood from the following detailed description when read in conjunction with the appended drawing, in which:

### BRIEF DESCRIPTION OF DRAWINGS

FIG. 1 shows the top view of a Germany keyboard;

FIG. 2 shows the top view of an English keyboard;

FIG. 3 shows the perspective view of the present invention;

FIG. 4 shows the block diagram of the present invention;

FIG. 5 shows the flowchart of operation of the single-chip microprocessor of the present invention;

FIG. 6 shows the table of key code of the present invention; and

FIG. 7 shows the perspective view of another preferred embodiment of the present invention;

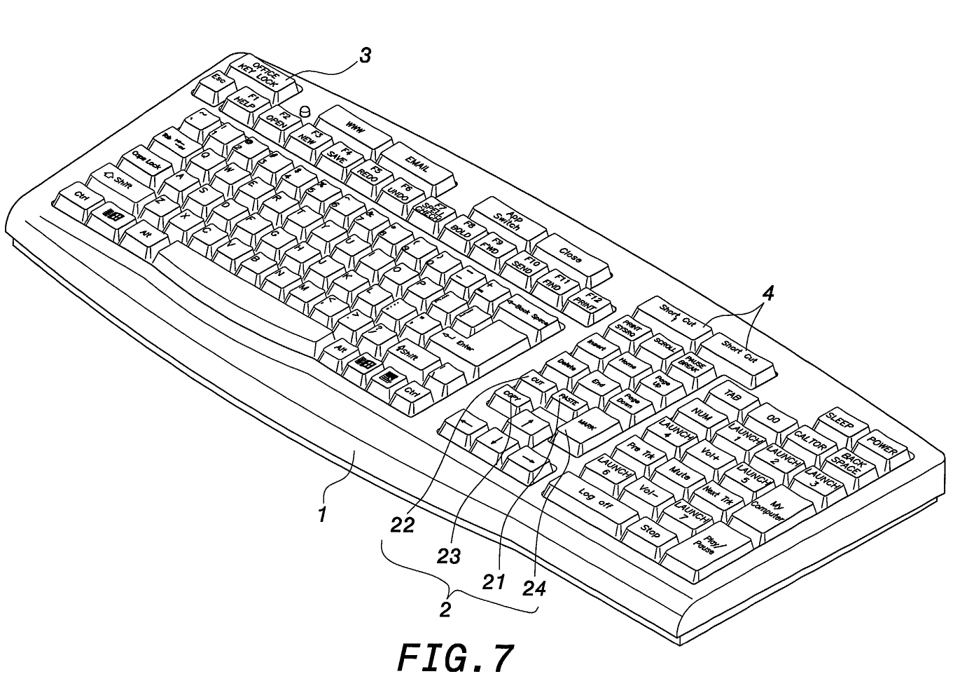

FIG. 8 shows the application of the present invention to a Windows keyboard.

### DESCRIPTION OF THE INVENTION

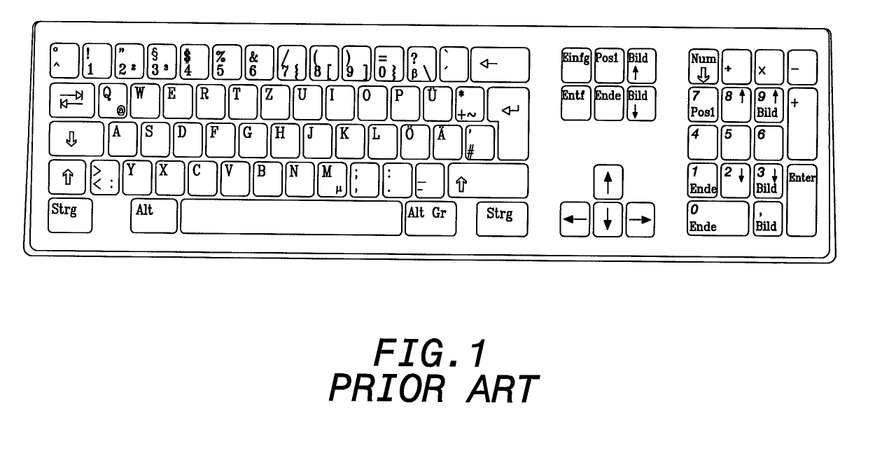

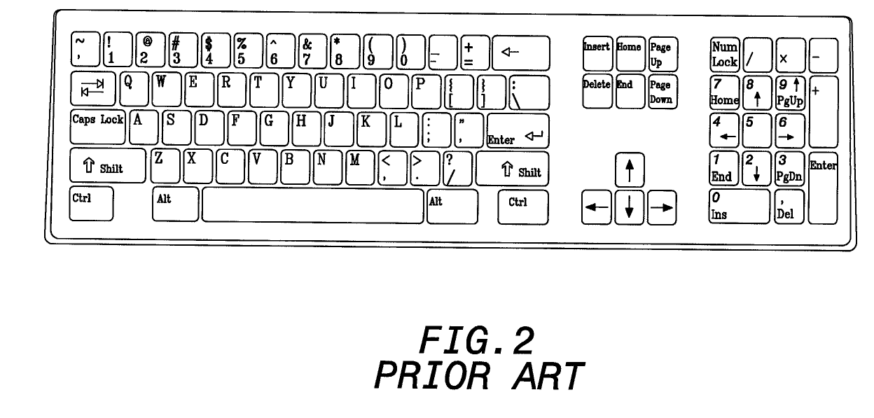

As shown in FIGS. 1 and 2, the present inventions provides an auxiliary device for editing document, which comprises a computer peripheral 1 and a modular key set 2 with document editing function.

In the preferred embodiment of the present invention, the computer peripheral 1 is a keyboard having a single-chip microprocessor 11 in the internal circuit thereof.

The modular key set 2 is placed beside the Shift key on the keyboard and is connected to I/O bus of the single-chip microprocessor 11 in the internal circuit of the keyboard. The modular key set 2 is composed of function keys such as cut key 21, paste key 22, copy key 23 and mark key 24.

The user uses the mark key 24 to mark a segment of document, the cut key 21 to cut the document segment in the marked region, and up arrow, down arrow, left arrow and right arrow to move cursor to a specific region. Afterward, the user can use the paste key 22 or the copy key 23 to paste or copy the selected document segment to the position of cursor.

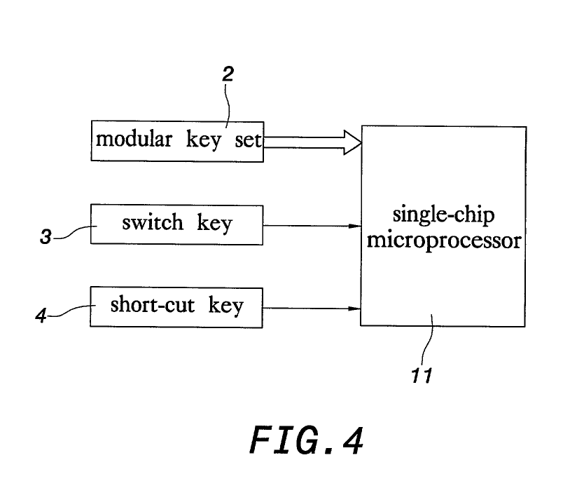

When user presses any key in the modular key set 2, the single-chip microprocessor 11 detects the keystroke of the key in the modular key set 2 and generates a pseudo composite-key code. FIG. 4 shows the relationship between the function keys in the modular key set 2 corresponding to the composite-keys. As can be seen from the figure, the composite keys corresponding to the cut key 21 is CTRL+X, the composite keys corresponding to the paste key 22 is CTRL+V (holding CTRL pressed and pressing V, then releasing both keys simultaneously) or ALT+E, P (holding ALT pressed and pressing E, then releasing both keys simultaneously, and then pressing P), the composite keys corresponding to the copy key 23 is CTRL+C, and the composite keys corresponding to the mark key 24 is left Shift or right Shift.

The different computer may have different processing speeds; therefore, the microprocessor 11 may generate the pseudo composite-key code with speed different to the generating speed of ordinary key. In the preferred embodiment of the present invention, the separation between the issuing of pseudo composite-key code corresponding to the function keys in the modular key set 2 is at least 1.5 to 2 ms. Otherwise, few computer may have malfunction.

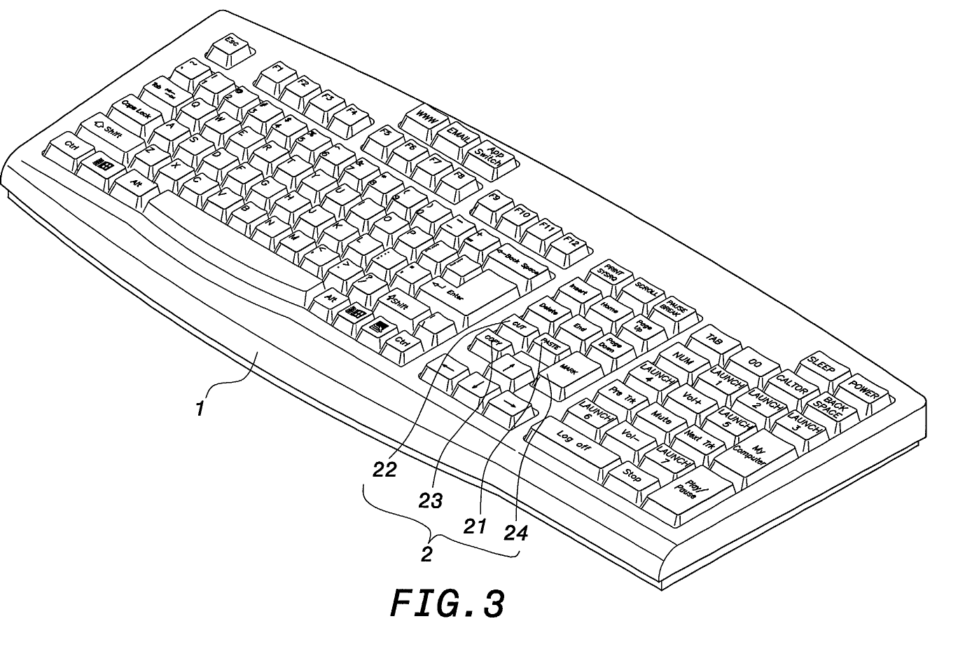

FIG. 3 shows the flowchart of the microprocessor 11 in the preferred embodiment of the present invention.

After step 30 of powering on computer, the microprocessor 11 is first in reset state (step 31) and then begins security test (step 32). Afterward, if a command is sent to the microprocessor 11 in step 33, the microprocessor 11 executes the command in step 331 and in step 332 the microprocessor 11 judges whether the scan counter time is ended. If the scan counter time is not ended, the microprocessor 11 judges whether the flag time is ended in step 34. If the flag time is ended, the key code is sent in step 35, else the procedure is back to step 33.

If the scan counter time is ended, the microprocessor 11 scans each key in step 36 and judges whether a function key is pressed in step 37.

If no function key is pressed, the procedure is back to step 33, else the microprocessor 11 judges whether any key in the modular key set 2 is pressed in step 38.

If no key in the modular key set 2 is pressed, the flag corresponding to this state is stored in buffer in step 382 and then the procedure is back to step 33. If certain key in the modular key set 2 is pressed, the flag corresponding to this state is set and stored in buffer in step 382.

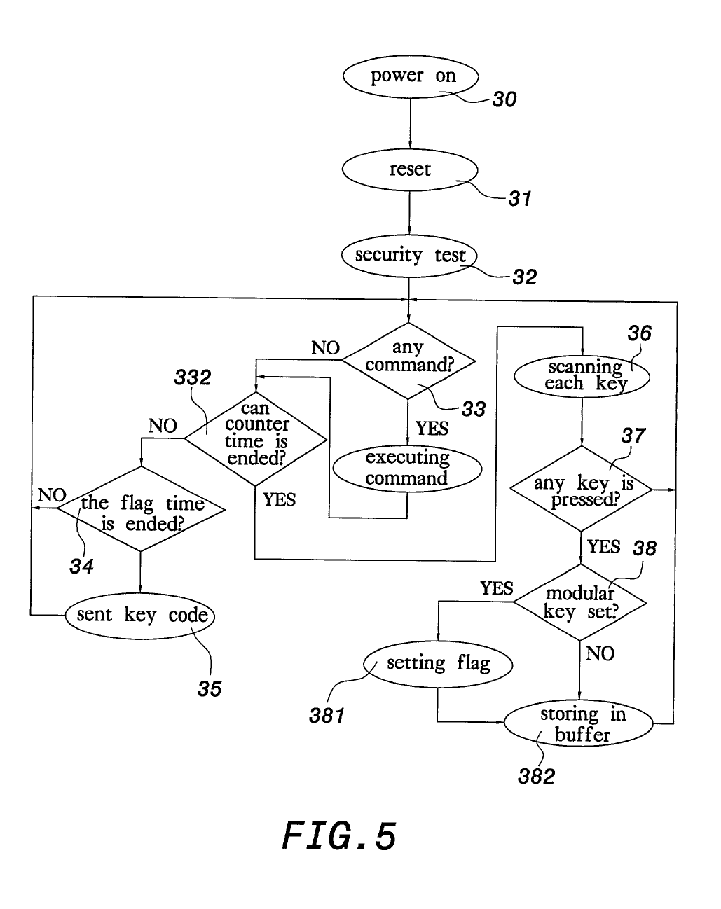

With reference now to FIGS. 2 and 5, in another preferred embodiment of the present invention, a switch key 3 is provided on the left-top corner of the keyboard 1 and the switch key 3 is connected to the I/O bus of the microprocessor 11. The switch key 3 is used to switch the mode of the function keys F1-F12 between ordinary function and augmentation function. The augmentation function including redo, undo, open, new, bold, save, find, forward and send etc. In other word, the microprocessor 11 has two different key code tables to switch the function of the function keys F1-F12 between ordinary function and augmentation function. The function of the function keys F1-F12 can be expanded while no new keys are necessary.

When the switch key 3 is pressed, the function keys F1-F12 have augmentation function as shown in FIG. 4. As can be seen from the table, the composite-key code for redo is ALT+E, R; the composite-key code for undo is ALT+E, U; the composite-key code for open is CTRL+O or ALT+E, O; the composite-key code for new is CTRL+N or ALT+E, N; the composite-key code for change to bold form or normal form is CTRL+B; the composite-key code for save is CTRL+S or ALT+E, S; the composite-key code for find is CTRL+F or ALT+E, F; the composite-key code for forward file is ALT+F, D; and the composite-key code for send file is ALT+S.

If the switch key 3 is pressed again, the function keys F1-F12 are switched back to ordinary functions. The state of the switch key 3 can be manifested by a light-emitting element.

The code conversion of the composite-key code in the present invention can be embodied by sending specific code to a code-conversion application software, thus enabling or disabling the key code of the function keys F1-F12.

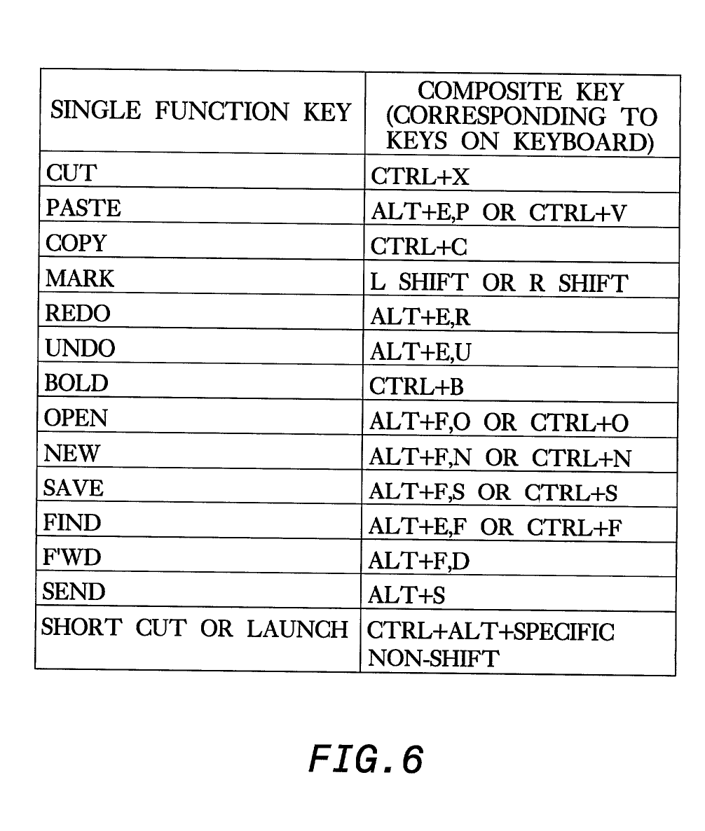

Moreover, in still another embodiment of the present invention, a short-cut key (or launch key) 4 is provided. The short-cut key 4 is connected to the I/O bus of the microprocessor 11. As shown in FIG. 6, the code corresponding to the short-cut key 4 is CRTL+ALT+ specific non-shift key.

When user presses the short-cut key 4, he can execute any programs without any driver program. For example, the user can open the content of a program on the desktop. In the short-cut section, the user presses the short-cut key 4 and select confirm to associate the program with the short-cut key 4. Afterward, the user can directly press the short-cut key 4 to launch the program.

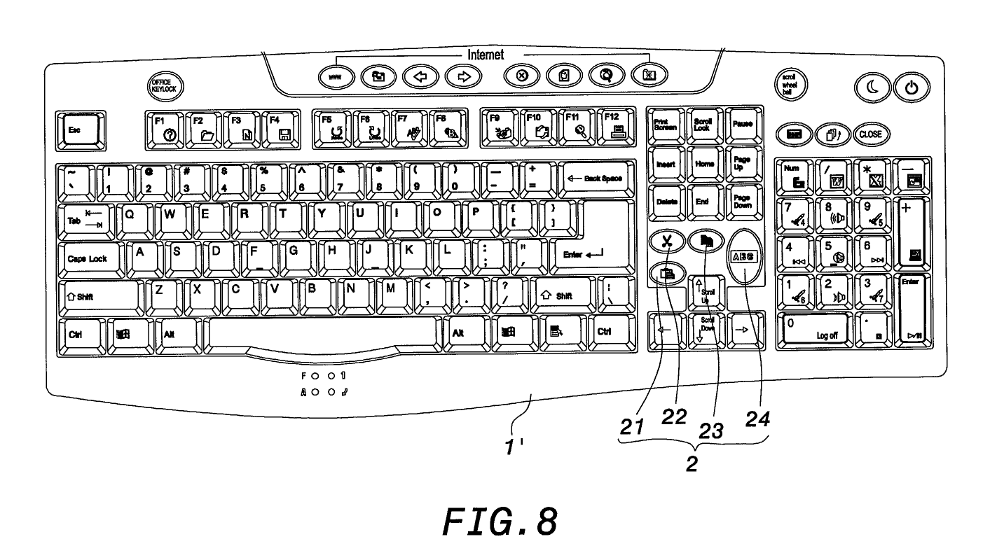

As showing FIG. 8, the present invention can also be applied to a Windows keyboard.

To sum up, the auxiliary device for editing document has following advantages:

(1) The user can directly use the modular key set to edit document without invoking conventional composite key or mouse.

(2) The modular key set can be operated stand-alone and does need the support of keyboard driver. Therefore, the modular key set does not have the problem of software compatibility.

(3) The user can use short-cut key to start any function associated with the short-cut key. It is very convenient.

(4) The area of the keyboard does not require enlargement.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

For examples, as shown in FIG. 6, the combination of operations such as pressing, releasing and pressing again over those keys shift, CTRL and ALT is also embraced in the scope of the present invention.

I claim:

1. An auxiliary device for editing document, comprising
a computer peripheral having an internal circuit with a single-chip microprocessor; and
a modular key set with document editing function; the modular key set arranged on the computer peripheral and connected to an I/O bus of the single-chip microprocessor; the single-chip microprocessor generating a pseudo composite-key code corresponding to a key in the modular key set pressed by a user; whereby the user can directly edit document by using the modular key set provided on the computer peripheral.

2. The auxiliary device for editing document as in claim 1, wherein a short-cut key is further provided on the computer peripheral to invoke an associated program.

3. The auxiliary device for editing document as in claim 1, wherein the computer peripheral is provided with a plurality of composite keys and the functions of the composite keys are control by a switch key, the switching state of the switch key can be manifested by a light-emitting element.

4. The auxiliary device for editing document as in claim 1, wherein the composite keys are function keys F1-F12.

5. The auxiliary device for editing document as in claim 1, wherein the code conversion of the composite-key code can be embodied by sending specific code to a code-conversion application software

6. The auxiliary device for editing document as in claim 1, wherein the computer peripheral is a keyboard.

7. The auxiliary device for editing document as in claim 1, wherein the modular key set is composed of cut key, paste key, copy key and mark key.

8. The auxiliary device for editing document as in claim 1, wherein the key code of the modular key set has separation larger than 1.5-2 ms.

9. The auxiliary device for editing document as in claim 1, wherein the modular key set is arranged beside the Shift key on keyboard.

10. The auxiliary device for editing document as in claim 7, wherein the composite keys corresponding to the cut key is CTRL+X.

11. The auxiliary device for editing document as in claim 7, wherein the composite keys corresponding to the paste key is CTRL+V, or ALT+E, P

12. The auxiliary device for editing document as in claim 7, wherein the composite keys corresponding to the copy key is CTRL+C.

13. The auxiliary device for editing document as in claim 7, wherein the composite keys corresponding to the mark key is left Shift or right Shift.

14. The auxiliary device for editing document as in claim 3, wherein the composite keys including the functions of redo, undo, open, new, bold, save, find, forward and send.

15. The auxiliary device for editing document as in claim 14, wherein the composite-key code for redo is ALT+E, R

16. The auxiliary device for editing document as in claim 14, wherein the composite-key code for undo is ALT+E, U

17. The auxiliary device for editing document as in claim 14, wherein the composite-key code for bold is CTRL+B.

18. The auxiliary device for editing document as in claim 14, wherein the composite-key code for open is CTRL+O, or ALT+F, O

19. The auxiliary device for editing document as in claim 14, wherein the composite-key code for new is CTRL+N, ALT+F, N.

20. The auxiliary device for editing document as in claim 14, wherein the composite-key code for save is CTRL+S, or ALT+P, S

21. The auxiliary device for editing document as in claim 14, wherein the composite-key code for find is CTRL+F, or CTRL+E, F.

22. The auxiliary device for editing document as in claim 14, wherein the composite-key code for forward file is ALT+F+D.

23. The auxiliary device for editing document as in claim 13, wherein the composite-key code for send file is ALT+S.

24. The auxiliary device for editing document as in claim 13, wherein the composite-key code for short-cut key is CRTL+ALT+specific non-shift key.

25. The auxiliary device for editing document as in claim 1, wherein the pseudo composite-key code comprises the combination of operations such as pressing, releasing and pressing again over those keys shift, CTRL and ALT is also embraced in the scope of the present invention.
